(19) United States
(12) Patent Application Publication
(10) Pub. No.: US 2023/0286826 A1
(43) Pub. Date: Sep. 14, 2023

(54) MIXED METAL OXIDE POWDERS AND METHODS FOR MANUFACTURING THEREOF

(71) Applicant: Advanced Energy Materials, LLC, Louisville, KY (US)

(72) Inventors: Mahendra Kumar Sunkara, Louisville, KY (US); Vivekanand Kumar, Louisville, KY (US); Tu Q. Nguyen, Louisville, KY (US)

(21) Appl. No.: 18/120,673

(22) Filed: Mar. 13, 2023

Related U.S. Application Data
(60) Provisional application No. 63/319,443, filed on Mar. 14, 2022.

(51) Int. Cl. C01G 53/00; C01G 9/00; C01G 23/08; C01F 7/043; C01G 41/02; C01G 41/00; C01G 23/00; H01M 4/505; H01M 4/525

(52) U.S. Cl. CPC C01G 53/50; C01G 9/006; C01G 23/08; C01F 7/043; C01G 41/02; C01G 41/006; C01G 23/005; H01M 4/505; H01M 4/525; C01P 2006/40; C01P 2004/16; C01P 2004/84; C01P 2002/54; C01P 2002/72; C01P 2004/03; C01P 2002/85; C01P 2004/04

(57) ABSTRACT

A method of manufacturing a mixed metal oxide powder is provided. The method includes steps of mixing two or more metal precursors in a solvent to form a dispersion of the metal precursors in the solvent; drying the dispersion to obtain a dried mixed metal precursor powder; jet milling the dried mixed metal precursor powder to obtain particles having a size distribution in a range of 0.2-20 micrometers; and exposing the particles to a hydrocarbon flame or oxygen plasma to provide the mixed metal oxide powder. Mixed metal oxide powders produced by the disclosed methods are also provided.

### CROSS-REFERENCE TO RELATED APPLICATIONS

This application claims the benefit of U.S. Provisional Patent Application 63/319,443 filed on Mar. 14, 2022, the complete contents of which are herein incorporated by reference.

### FIELD OF THE INVENTION

The present disclosure is directed to mixed metal oxide powders. More particularly, the present disclosure is directed to a pyrolytic method for manufacturing mixed metal oxide powders.

### BACKGROUND OF THE INVENTION

Mixed metal oxides find a variety of uses in the industry, as may be well known to a person of ordinary skill in the art. Various methods have been employed in the art for manufacturing these mixed metal oxides. A typical example of mixed metal oxides includes lithium nickel manganese cobalt oxide, which is widely used in electrochemical energy storage devices. One method in the art for manufacturing mixed metal oxides may include a solid state method wherein metal precursors are mechanically milled together to form the desired mixed metal oxides. Another method may include wet chemical methodologies such as sol-gel, and co-precipitation solvothermal techniques among others. However, a person skilled in the art may be aware that these methods may result in lower yields as they involve multiple steps and laborious processes, each bearing a risk of introducing impurities into the final product in addition to creating batch-wise inconsistencies in the process.

Newer approaches in the art for manufacturing mixed metal oxides include flame pyrolysis approaches. However, in many of these flame/electric furnace pyrolysis techniques, mixed metal oxides with desired particle size and crystallinity may require additional post-treatment annealing step. Certain other techniques used in the art may employ plasma oxidation of liquid precursor droplets for producing mixed metal oxide nanoparticles. However, this technique may lead to operational issues involving handling large amounts of liquid evaporation, quenching of plasma torches through liquid condensation, and low loading capability for production. Recent methods for manufacturing mixed metal oxides include plasmas and liquid droplets wherein the precursors may be dissolved in organic solvents. Liquid phase precursors (using both flame and plasma) may result in porous lighter nano powders with lower control on size and may again require additional post-treatment calcination step to obtain micron size hard spheres.

Thus, there exists a need in the current systems for methods of manufacturing mixed metal oxides which require less time, effort, and skill, and are cost effective.

### SUMMARY

One aspect of the invention provides a method of manufacturing mixed metal oxides. The method may include a first step of mixing two or more metal precursors in a predetermined stoichiometry in a solvent resulting in the formation of a uniform dispersion of the metal precursors. In a second step, the uniform dispersion is dried to obtain a dried mixed metal precursor powder including a mixture of the metal precursors. In a third step, the dried mixed metal precursor powder is jet milled to obtain spherical aggregated particles of the mixed metal precursor powder, wherein the spherical aggregated particles may have a narrow particle size distribution in a range of from about 0.2 micrometers to about 20 micrometers. In a fourth step, the spherical aggregated particles of the dried mixed metal precursor powder may be exposed to a hydrocarbon flame or oxygen plasma. As a result, the spherical aggregated particles of the dried mixed metal precursor powder are converted to a complex metal oxide product in a residence time of, for example, less than or equal to about 1 minute.

In some embodiments, the two or more metal precursors comprise metals selected from the group consisting of nickel, manganese, cobalt, copper, zinc, gallium, molybdenum, titanium, tungsten, and iridium. In some embodiments, the two or more metal precursors are metal salts which may be selected from the group consisting of nitrates, acetates, sulfates, formates, and combinations thereof. In some embodiments, the solvent is an aqueous solvent. In some embodiments, the drying step is performed to reduce a moisture content of the dried mixed metal precursor powder to less than 40% by wt. In some embodiments, in the exposing step, the particles are heated at a rate of 500-3000° C. per minute. In some embodiments, the exposing step is performed for 10-120 seconds. In some embodiments, in the exposing step, the particles are exposed to an atmospheric pressure microwave plasma, radio frequency plasma torch, or any other form of plasma excitation. In some embodiments, the dried mixed metal precursor powder is fluidized for exposure to the hydrocarbon flame or oxygen plasma. In some embodiments, the method does not include any additional annealing or calcination step. In some embodiments, a lithium precursor is added before or after the exposing step. In some embodiments, the lithium precursor may be lithium carbonate or lithium hydroxide.

In some embodiments, the method is repeated to provide core-shell mixed metal oxide particles having different compositions in each layer of the core-shell mixed metal oxide particles. For example, in some embodiments concentration-gradient core-shell mixed metal oxide structures are produced.

Another aspect of the disclosure provides a mixed metal oxide powder obtained by a method as described herein.

### BRIEF DESCRIPTION OF THE DRAWINGS

The accompanying drawings, which are incorporated in and constitute a part of this disclosure, illustrate exemplary embodiments and, together with the description, serve to explain but not limit the disclosed principles.

FIG. 1A-B provides a block diagram of (a) a process for manufacturing mixed metal oxides as disclosed herein in accordance with embodiments of the present disclosure in comparison with (b) a traditional hydrothermal method used for synthesis of lithium nickel manganese cobalt mixed oxide and other related complex metal oxides.

FIG. 2 provides a schematic of the microwave plasma reactor for scaling up the process for manufacturing mixed metal oxides in accordance with embodiments of the present invention.

FIG. 3 provides a schematic of the microwave plasma reactor for scaling up the process for manufacturing mixed metal oxides in accordance with embodiments of the present invention.

FIG. 4A-D. (a) XRD pattern of Li-NMC811, charge-discharge curves of (b) Li-NMC811 and (c) LiNi_{0.65}Mn_{0.35}Co_{0.05}O₂ cathode electrode, and (d) voltage-capacity vs cycle number curves of LiNi_{0.65}Mn_{0.35}Co_{0.05}O₂ at the voltage range of 4.3-2.5 V with 20 mA/g rate.

FIG. 5A-D. (a-I) X-ray diffraction patterns of NMC as-prepared sample from atmospheric microwave plasma (a-II) X-ray diffraction reflections after solid state lithiation of NMC, (b-I) XRD of Ni-rich Ni_{0.6}Mn_{0.2}Co_{0.2}Oₓ as-prepared sample from microwave plasma (b-II) X-ray diffraction reflections after solid state lithiation. (c) Capacity v. voltage plot for 1^{st}, 2^{nd}, 10^{th}, 20^{th}, 30^{th}, 40^{th} and 50^{th} cycle. (d) Capacities versus cycle number of LiMn_{0.6}Ni_{0.2}Co_{0.2}O₂ cathode electrode at a current of 10 mAg⁻¹ over 50 charge-discharge cycles. The secondary axis shows the Coulombic efficiency over 50 cycles.

FIG. 6A-D. Examples of mixed metal oxide alloy powders. (a) SEM image of morphology and EDS elemental mapping of W_{0.99}Ir_{0.1}O₃₋ₓ. (b) Ni—Mo alloy particles dispersed uniformly on Titania NWs. (c) (c-I) XRD patterns of NMC Ni_{0.6}Mn_{0.2}Co_{0.2}Oₓ as-prepared sample and (c-II) XRD patterns after solid state lithiation of NMC262. (d) SEM image of LiNMC 262 particles and capacity v. voltage plot.

FIG. 7. Schematic of a fluidized bed using microwave plasma reactor.

FIG. 8A-C. (a) SEM images of TiO₂ powder before and after jet milling, (b) particle size distribution reduced from D50: 200 μm to D50: 8 μm, and (c) photograph of a 4 inch size jet mill.

FIG. 9. Schematic showing steps for synthesis of concentration-gradient core-shell mixed metal oxide structures.

FIG. 10A-C. SEM of NiMo MMO loaded on TiO₂ NWs (a) using wet impregnation method and (b) using plasma intensification method. (c) XRD graph XRD pattern of the as-synthesized NiMo nanoparticles loaded on TiO₂ NWs. The NiMo alloy peak was identified as PDF 00-033-0948, 01-086-0362 NiMoO₄.

FIG. 11A-D. (a) TEM image and EDS elemental mapping for (b) O, (c) W, and (d) Ir for particles of W_{0.99}Ir_{0.01}O_{3-δ}.

FIG. 12A-B. (a) First charge-discharge curves of LiMn_{0.6}Ni_{0.2}Co_{0.2}O₂ and 5 nm Al₂O₃ coated LiMn_{0.6}Ni_{0.2}Co_{0.2}O₂ electrode at the voltage range 4.6-2.0 V with current of 10 mA/g. (b) Discharge capacities versus cycle number of LiMn_{0.6}Ni_{0.2}Co_{0.2}O₂ and 5 nm-Al₂O₃ coated LiMn_{0.6}Ni_{0.2}Co_{0.2}O₂ electrode at the voltage range 4.6-2.0 V with current of 10 mA/g.

### DETAILED DESCRIPTION

Embodiments of the disclosure described herein provide mixed metal oxide (MMO) powders having a desired particle size and crystallinity. More particularly, aspects of the invention are directed to pyrolytic methods for manufacturing the mixed metal oxide (MMO) powders. The disclosure provides a process that may be termed here as Microwave Intensified Pyrolysis (MIP) for scalable manufacturing of mixed metal oxide (MMO) materials including at least two metals.

In one embodiment, there is provided a method of manufacturing a mixed metal oxide powder. The method includes steps of mixing two or more metal precursors in a solvent to form a dispersion of the metal precursors in the solvent; drying the dispersion to obtain a dried mixed metal precursor powder; jet milling the dried mixed metal precursor powder to obtain particles having a size distribution in a range of 0.2-20 micrometers; exposing the particles to a hydrocarbon flame or oxygen plasma and then recovering the mixed metal oxide powder. As a result, the spherical aggregated particles of the dried mixed metal precursor powder are converted to a complex metal oxide product in, for example, a residence time of less than or equal to about 1 minute.

In certain embodiments, the use of dense plasmas (radio frequency; microwave plasma; dielectric barrier discharge; arc discharge) at pressures ranging from 0.01-7 bars; radical densities ranging from 10¹⁰-10¹⁸ per cm³ or high temperature hydrocarbon flames may allow for rapid decomposition of precursors and increase in the rate of heating in a range of from about 500 degrees centigrade per minute to about 3000 degrees centigrade per minute through convective heating and radical recombination. In various embodiments, rapid heating of the well mixed, amorphous mixed metal may be necessary to create a mixed alloy crystalline material with composition control. Accordingly, the resulting powder includes a crystalline alloy of the mixed metal oxides with a desired phase, composition, and aggregate size.

In an exemplary embodiment, the rapid heating may include an increase in temperature of greater than about 800 degrees centigrade in a fraction of a second, e.g. equal to or less than 0.1-1 second. In one embodiment, there is provided a method for scalable production of crystalline mixed metal oxide powders with a fast reaction time of, for example, less than or equal to about a minute (<1 minute, e.g. 10-50 seconds, e.g. about 30 seconds) with a control on both composition and secondary size.

In an exemplary embodiment, the efficiency of energy transfer may be achieved by following a two-step process. The two-step process may include a first step of drying the metal precursors mixture into a well-mixed metal precursor solid powder and then subjecting the mixed metal precursor solid powder to atmospheric pressure microwave plasma for creating a complex metal oxide crystal in a residence time of less than or equal to about a minute without any additional calcination steps.

In various embodiments, the production may be accomplished using a variety of plasma or flame sources that may enable contacting the dried mixed metal precursor powder in solid form (i.e., aggregates as mentioned herein above) using equipment including but not limited to, a belt furnace, a fluidized bed reactor, and the like or combinations thereof. In some embodiments, the solid powder is exposed to an atmospheric pressure microwave plasma, radio frequency plasma torch, or any other form of plasma excitation.

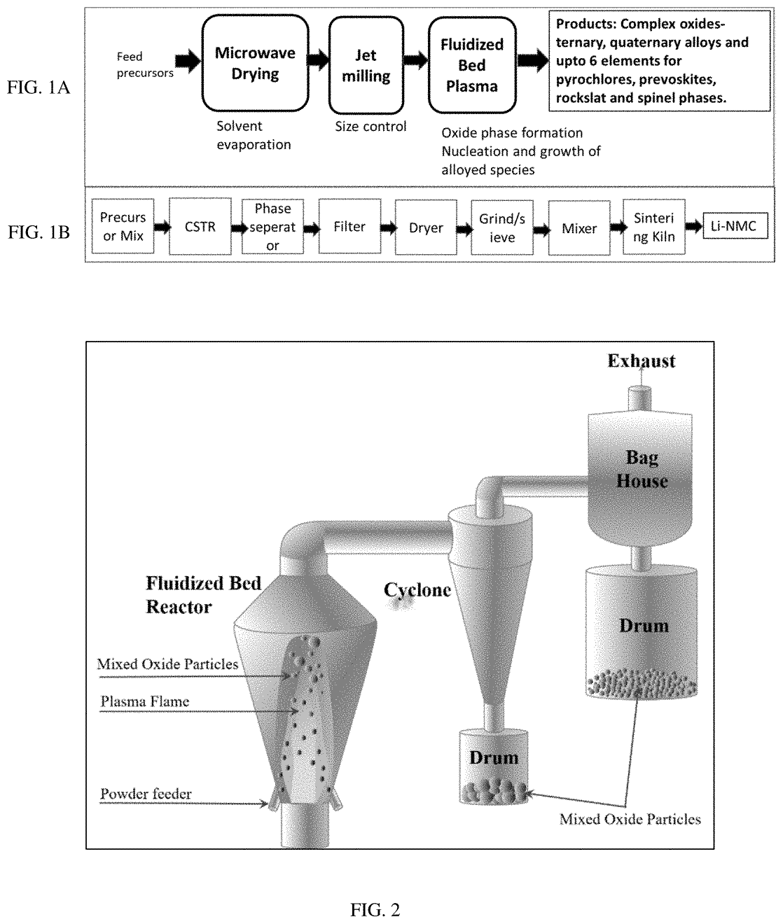

In an exemplary embodiment, as shown in FIG. 1, the metal precursors may be mixed in a solvent, e.g. an aqueous solvent, to prepare a solution containing the metal precursors with desired composition of various metal elements. In one embodiment, the mixed precursor solution may then be dried in a thermal oven or a microwave oven at temperatures less than that required for oxidation of the metal elements in the metal precursor and appropriate for solvent evaporation. For example, the mixed precursor solution may be dried at a temperature of 100-300° C. for a time sufficient for solvent evaporation, e.g. 5 minutes to 3 hours. In one exemplary embodiment, the drying may be carried out over a range of time periods that may avoid any segregation of the different metal precursors present in the solvent. In some embodiments, the drying step is performed for 5-20 minutes, e.g. 5-10 minutes. In some embodiments, the drying step is performed to reduce a moisture content of the dried mixed metal precursor powder to less than 40% by wt, e.g. a moisture content of 0.1-40%. The dried mixed metal precursor powders may then be jet milled using soft air flow rates to control shape and size of the dried mixed metal precursor powder particles with desired size distribution. In an exemplary embodiment, the shape may be spherical and the size may be in a range from about 0.2 micrometers to about 50 micrometers.

The temperature for precursor drying may be controlled to eradicate or minimize precursor decomposition, phase segregation, or oxidation of the mixed metal precursors. Furthermore, chemical composition and random mixing of the precursor materials may be controlled, and accordingly, the drying conditions may be optimized to perform solvent removal at controlled temperature.

The dry powders containing well mixed metal precursors of various metals and elements are then subjected to rapid oxidation using plasmas or flames either in a conveyer belt fashion or in a fluidized bed or combination of both. It is also desired in some cases to pre-warm the powders prior to subjecting them to plasma or hydrocarbon flame oxidation. For example, the powders may be pre-warmed at a temperature of ambient (e.g. about 20° C.) to about 150° C. The resulting powders with rapid oxidation results in mixed metal oxide crystalline powders with good composition and secondary size (aggregate) control. In an exemplary embodiment, direct plasma heating may allow for fast heating of the dried metal oxide precursor particles at a rate of about 3200° C. per minute, e.g. 2500-4000° C. per minute, through convective heating and radical recombination. Such fast heating of precursor mixture that may achieve a temperature greater that about 8000° C., e.g. about 7000-9000° C., within fraction of second may be necessary to create mixed alloy crystalline materials with composition control in accordance with embodiments of the present invention. The resulting metal oxide powders can be further shaped and densified using extruders combined with or without spheronizers depending upon the desired application of the metal oxide powders.

In one embodiment, the metal precursor may include suitable salts of any suitable metal that may result in the formation of the desired mixed metal oxide crystalline powder as described hereinabove. In an exemplary embodiment, the metal precursor may include nitrates, acetates, sulfates, formates, and the like of desired metal elements that when dried using a microwave form a dried mixed metal oxide of precursor chemicals in the same stoichiometric composition. Suitable metal elements include, but are not limited to, nickel, manganese, cobalt, aluminum, magnesium, zirconium, lanthanum, lithium, sodium, potassium, calcium, silicon, platinum, ruthenium, tin, indium, bismuth, vanadium, iron, silver, copper, zinc, gallium, molybdenum, titanium, tungsten, and iridium.

In an exemplary embodiment, the solvent may include any solvent that may be evaporated to obtain the dried mixed metal precursor powder using the method described herein. In an exemplary embodiment, the solvent may include water, organic solvents, such as methanol, ethanol, or other alcohols, and the like and combinations thereof. Since each droplet may contain the metal precursor material in the same stoichiometric composition as desired in the desired mixed metal oxide product particle, the synthesized particles may have exceptional compositional uniformity. In general, short reaction times allow for the formation of transient non-equilibrium phases (mixed metal oxide) whereas, long reaction times lead to equilibrium phases.

In an exemplary embodiment, the mixed metal oxide materials may include at least two metals. One skilled in the art will appreciate that any number of compatible metal precursors may be employed in the manufacturing of the mixed metal oxides. In one embodiment, the number of metals in the mixed metal oxide materials may be in a range of from about 2 to about 6 elements. The resulting mixed metal oxide particles can be single crystalline from 0.1-10 microns in size.

Referring to FIG. 2, a schematic of the microwave plasma reactor for scaling up the process for manufacturing mixed metal oxides in accordance with embodiments of the present invention is provided. As shown in FIG. 2, in an exemplary embodiment, the metal oxide precursors are mixed in water and dried first. The size control of dried solids is done by soft jet milling method which is key to obtain well defined micron size spheres. A jet mill uses a high-speed jet of compressed air (e.g. 80-100 psi) to impact particles into each other and the fine particles are collected in a bag house filter. Jet mills can output particles below a certain size, while continue milling particles above that size, resulting in a narrow size distribution of the resulting product. Particles leaving the mill can be separated from the gas stream by cyclonic separation. Control variables for a jet mill are powder feed rate and grind pressure. Example size ranges for various applications range from 1-10 microns in hydrodynamic radius. The micron size solid is then fed to the plasma from the bottom as shown in FIG. 2 and products collected in a bag house filter. Plasma exposure to solid spherical powders results in densification of the particles while retaining the original shape and thus allowing to obtain micron scale primary particle size control.

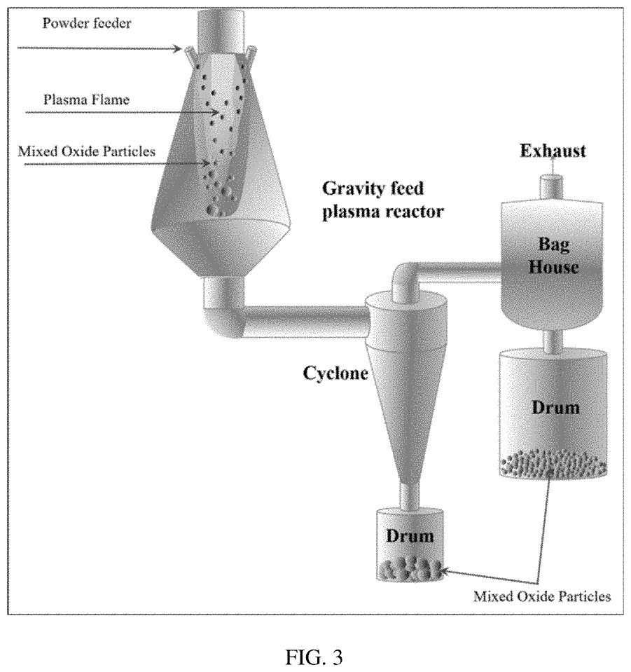

FIG. 3 provides a schematic of the microwave plasma reactor for scaling up the process for manufacturing mixed metal oxides in accordance with embodiments of the present invention. In an exemplary embodiment shown in FIG. 3, the reactor may also be configured to a gravity feed configuration by inverting the gas plasma flame vertically downwards. Plasma may be operated in downward position and precursors are fed at the top. This configuration may be utilized for plasma pyrolysis of heavier particles (>50 microns) which cannot be easily fluidized. Note that in this scheme, typical residence time of the particles through the plasma length (<1 sec) is of the same order as the synthesis time scales involving plasma discharge so that reactants are fully converted to products while exiting the plasma discharge region.

In one embodiment, the mixed metal oxide manufacturing method disclosed herein may be termed as a dry manufacturing technique and advantageously may improve the energy efficiency from about 4 kwh/kg (kilowatt hour per kilogram) to about 2 kwh/kg and shorter total processing time of about 29 minutes, e.g. 15 minutes to 5 hours, compared to about 20 hours as required in processes known in the art as shown in Table 1. In some embodiments, the entire manufacturing method is performed in 1 hour or less, e.g. about 15-45 minutes. Also, this approach is less likely to result in Li ion loss and further improves processing throughput.

Further, in one exemplary embodiment, as detailed in Table 1, the manufacturing costs may be reduced to as low as $2/Kg (excluding the cost of the metal oxide precursors) with improved energy efficiency. Even the precursors used herein are less expensive compared to those used in other techniques.

TABLE 1
Manufacturing costs using CAPEX and OPEX
but without the precursor costs

| | | Microwave Intensified |
|---|---|---|
| Metrics | State of the art - Thermal | Pyrolysis (MIP) scheme |
| Processing | Drying: >4 hrs | MW drying <10 mins |
| timescale | Calcination: 6-12 hrs | MW calcination |
| | | <15 mins |
| | Hydrothermal/co- | MIP <2 mins |
| | precipitation (>3 hrs) | |
| | Solid state alloying : (>4 | Inert MIP <2 min |
| | hrs) | |
| Overall mfg. | $5-$6/Kg (excluding | $2/Kg (excluding |
| cost of MMOs | precursors cost) | precursors) |
| (CAPEX, OPEX) | | |
| Overall energy | Calcination: 1.6 kWh/Kg | MW calcination: 0.5 |
| efficiency | | kWh/Kg |
| | Hydrothermal: 4 kWh/Kg | MIP: 1.6 kWh/Kg |
| | Drying: 1.62 kWh/Kg | 0.8 kWh/Kg |
| | Solid state alloying: 66 | Inert MIP: 1.6 kWh/Kg |
| | kWh/Kg | |
| Processability | Multi-step process, wet | Drying, Pyrolysis, |
| | manufacturing | Solid- |
| | | state alloying, dry |
| | | manufacturing |

Advantages of the manufacturing method disclosed herein may allow for scalable manufacturing of mixed metal oxide powders, such as for example, Li-NMC (lithium nickel manganese cobalt) oxide powders using the concept of rapid oxidation/heating of dried metal precursor powders. As demonstrated herein, the process offers scalability, size and composition control. A fluidization approach also helps with coating the powders using conducting polymers and thin inorganic coatings by introducing vapor phase precursors into the chamber. Such coatings can also be used to protect the resulting Li-NMC powders from absorbing moisture and developing LiOH on surfaces. Example precursors could include aluminum containing vapor phase precursors (alumina coating), titanium containing vapor phase precursors (titania coating), carbon containing hydrocarbons (carbon coating) and monomers (conducting polymers). The coatings can be added either simultaneously during the mixed metal oxide powder formation or can be added after they are formed in a separate chamber.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### Example 1. Production of NMC Powders

Nickel manganese cobalt oxide (NMC) comprise a class of lithium intercalation compounds with formula LiNiₓMn_{y}Co_{z}O₂ and are the cathode materials of interest for Li-ion battery for high energy density applications. Solid-solutions involving all three (Ni, Mn, Co, or NMC), LiNiₓMn_{y}Mn_{1-x-y}O₂, has proven an excellent way of circumventing most of the problems arising from the standalone lithium-transition-metal layered oxide cathodes. Variations of the NMCs are the lithium-rich NMCs, nickel-rich NMCs and manganese-rich NMCs, each with its distinctive features.

MIP process has been demonstrated with a variety of NMC materials systems at grams scale using batch mode experimentation. We demonstrated the production of coated (with thin alumina layer) and uncoated NMC cathode materials.

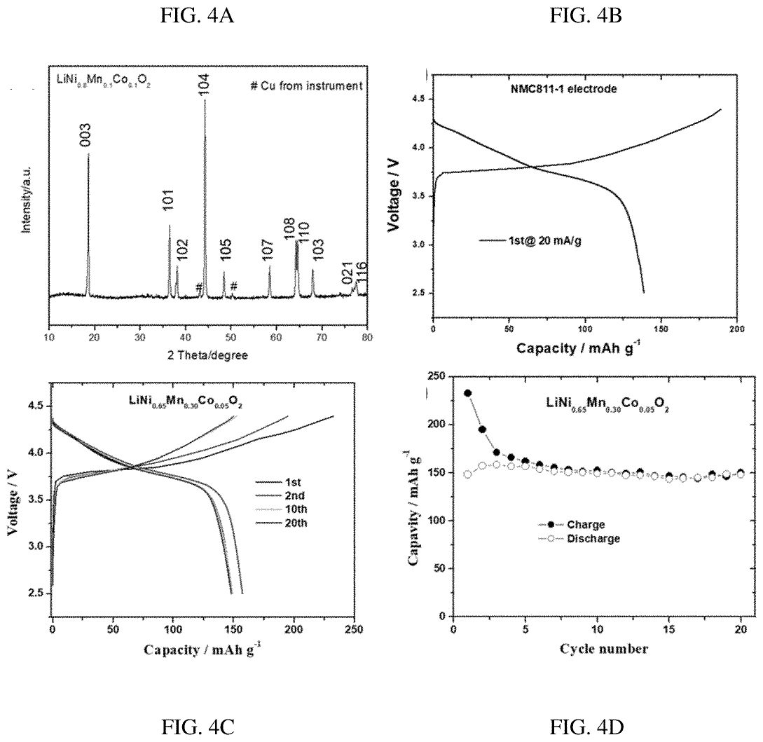

Li-NMC811 (LiNi_{0.8}Mn_{0.1}Co_{0.1}O₂) materials are created in one step using the MIP process described herein, i.e., nitrate precursors are mixed in water and then dried and then exposed to plasma flame to produce the layered structured Li-NMC 811 composition as shown in XRD data in FIG. 4a. Initial cycle data (FIG. 4b) shows discharge capacities of −130 mAh/g during the initial cycles data at 20 mA/g in the voltage range of 4.3-2.5 V. Note that preliminary capacity may be further enhanced by producing the materials in a fluidized bed reactor for complete conversion.

MIP scheme of plasma oxidation of dried precursors has been used to create low cobalt containing Li-NMC composition (Ni:Mn:Co: 65:30:5) as shown in FIG. 4c-d for LiNi₆₅Mn₃Co_{0.05}O₂ materials. Capacity also shows parasitic reaction due to electrolyte decomposition and can be overcome using additives such as Fluoroethylene Carbonate (FEC).

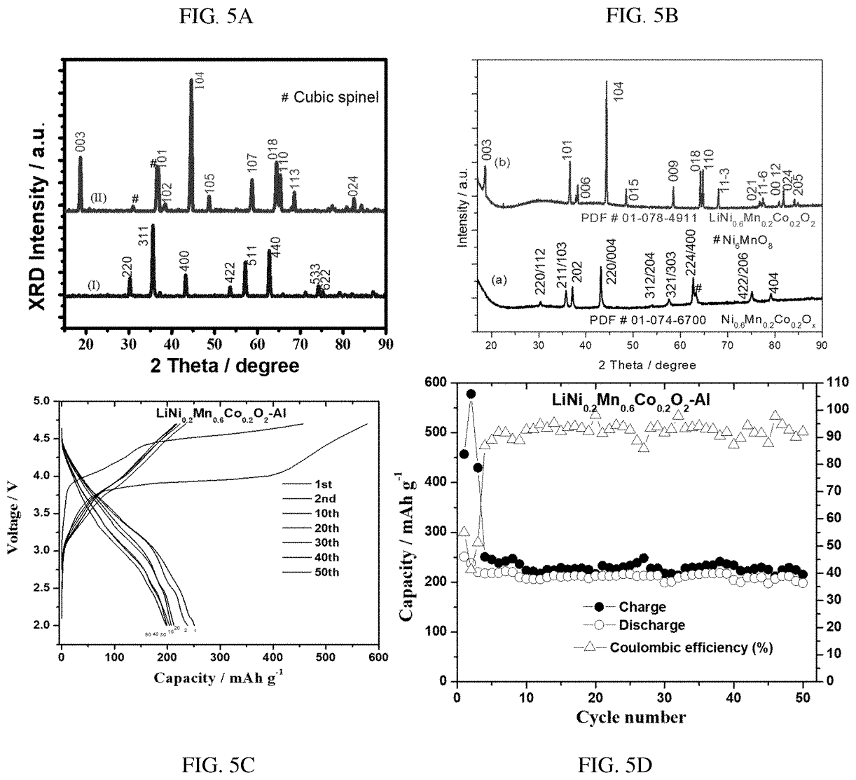

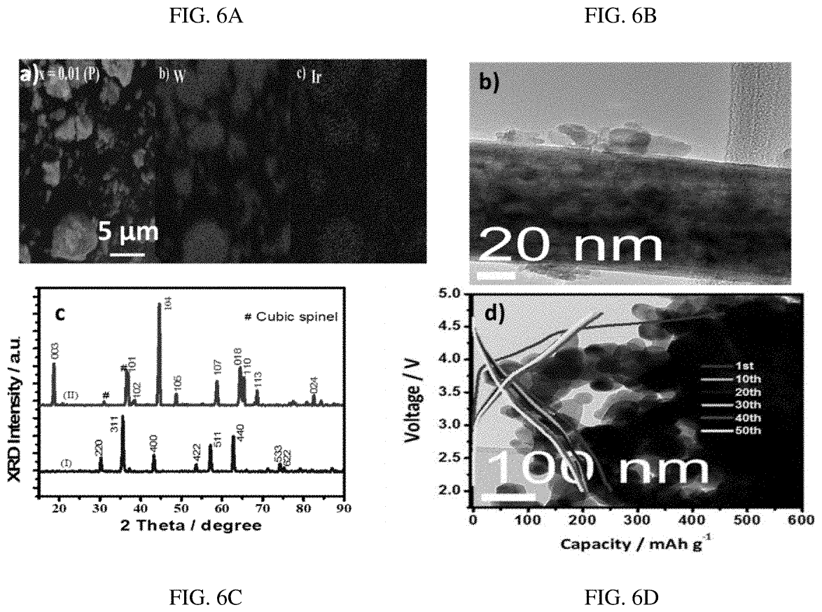

Result of plasma produced NMC262 cathode electrode shows discharge capacity of 210 mAh/g after 50 cycles (FIG. 5)

### Example 2. Production of Other MMO Powders

MIP process has also been proven with a variety of mixed metal oxide (MMO) materials including multi-component materials and compositions containing up to six elements which are not approachable with other conventional methods. Successes with this scheme include the following:
CuₓZn₁₋ₓO alloyed NWs, Ni—Mo supported on TiO₂ NWs, and lithium aluminate NWs have been produced using the MIP process.
Ni₃Ga₅ oxide and Ni₅Ga₃ oxide are produced (in 100-200 grams) for catalysts reaction
W—Ir-oxide alloy particles (W_{0.99}Ir_{0.01}O₃₋ₓ) with Ir content as low as 0.5 at % has been made at quantities greater than 10 grams using this technique.
Solid state alloying using plasma for making mixed metal oxide nanowires are used to create lithium aluminate, lithium tungstate and Cu—ZnO nanowires.

### Example 3. Demonstration of 100 g Scale Production of NMC Powder with Various Compositions without Fluidization

This is performed using thermally dried precursor powder (using conventional box oven). The purpose is to operate microwave fluidized bed plasma without fluidization set up to obtain baseline performance data for plasma pyrolysis at 100 gram scale. Currently, this procedure is used to make Li-NMC powders. To synthesize NMC 811 or NMC 955, nitrate precursors of Ni, Mn and Co chemically pure grade of nickel (II) nitrate hexahydrate, manganese (II) nitrate hydrate, and cobalt (II) nitrate hexahydrate are used as starting materials. For example, to prepare NMC 811, The precursor solutions containing stoichiometric amounts of nitrates of nickel (233 g), manganese (25 g), cobalt (23 g), is dissolved in 96 ml, 21 ml, 27 ml DI water to synthesize the 97 g of NMC 811 material and these materials are dried in microwave/conventional dryer. The amount of water used is based on the solubility limit of the precursors used. Slurry (containing dissolved precursors of nitrate salts of Ni, Mn and Co) will have about will 66% solids and remaining DI water. Slurry is dried in a box furnace at 200 deg C. for 2 hours until completely dried. The dried powder was exposed manually to open microwave plasma flame maintained at 1-2 kW power with air flow rate of 10-15 slpm.

TABLE 2
Composition of precursors material to produce Li-NMC811

| | | | molar |
|---|---|---|---|
| LiNi_{0.8}Mn_{0.1}Co_{0.1}O₂ (97 g/mol) | grams | moles | mass |
| Nickel nitrate hexahydrate | 23.3 | 0.08 | 290.8 |
| Manganese nitrate tetrahydrate | 2.5 | 0.01 | 251 |
| Cobalt nitrate hexahydrate | 2.3 | 0.01 | 229 |
| Lithium hydroxide | 2.64 | 0.11 | 24 |
| Total NMC produced (0.1 mol) | 9.7 | 0.1 | 97 |

Two approaches for Li-NMC materials are used during the process, in-situ NMC (Lithium carbonate/Lithium hydroxide is mixed along with the precursors) and post processing of NMC (Lithium carbonate/Lithium hydroxide is mixed after synthesizing the NMC). To synthesize Li-NMC, the obtained NMC oxide material will be crushed and well mixed in the solid state with an appropriate amount of lithium precursor in such a way that the stoichiometric ratio of lithium to NMC will be about 1:1 (e.g. 0.5:1 to 1:0.5), where a 5 wt. % excess of Li₂CO₃ will be added to compensate for the volatilization of lithium in the high temperature reaction. The mixture will be fed to the fluidized plasma reactor along with NMC material. During in-situ processing, the lithium precursor is premixed with the dry nitrate precursors and fed to the plasma fluidized reactor.

### Example 4. Demonstration Using Fluidized Bed Set Up at 1 Kg/Day Scale Demo MIP Process

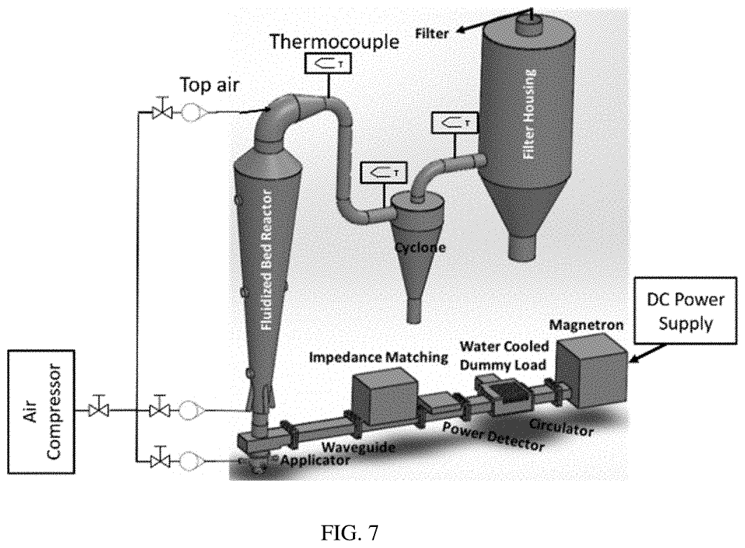

Experiments were performed using the setup shown in FIG. 7. Reactor set up includes (1) a plasma producing source (comprising a 3 kW MKS ASTEX power supply unit, a 2.45 GHz magnetron, a circulator, dummy load, forward and reflect power detector, and a three stub-tuner), (2) a custom designed WR284 rectangular channel waveguide applicator, (3) entry port for gases inlet, (4) a conical stainless steel enclosure (with 3 feet in length and maximum 10 inch width) for the reactor with jacketed water cooling, (5) bag house filter (effective surface area 10 sq. ft.) for fine powder collection, (6) cyclone (with >95% collection for 5 um size particles) for heavier powder collection, and (7) exhaust line for exhaust gases. The dried precursors decompose during the reaction with plasma ions/oxygen radicals and formation of alloys lead to final NMC materials.

### Example 5. Jet Milling of Dried Powders and Size Control

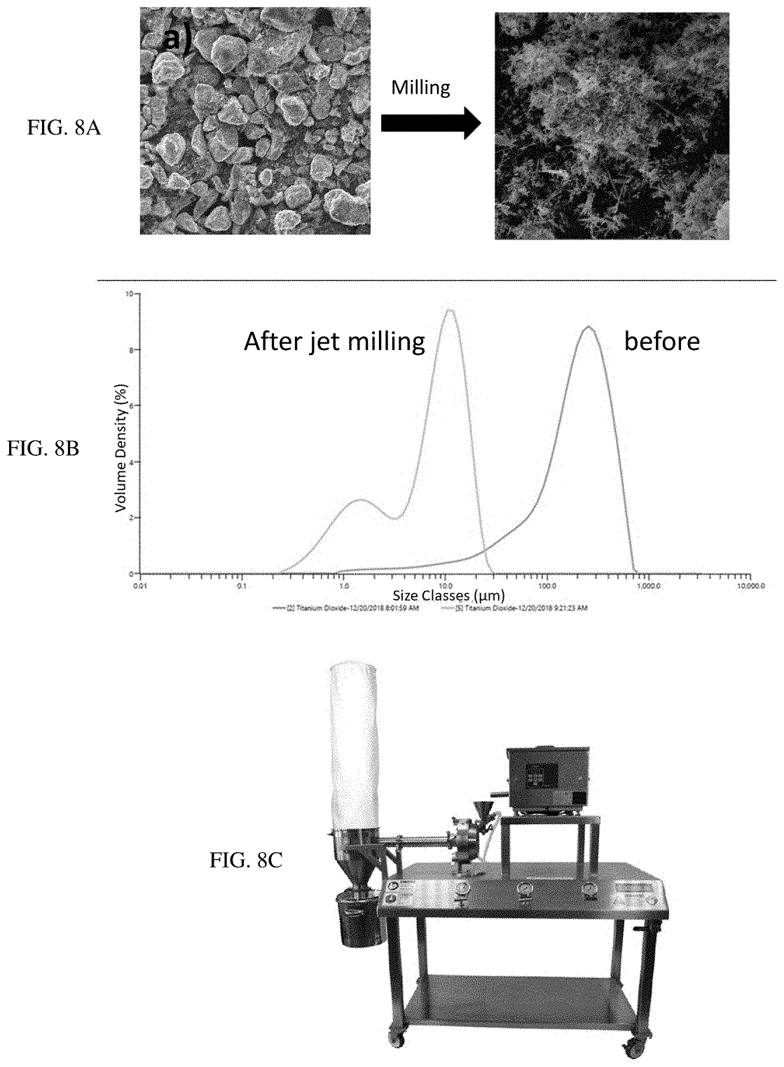

Powder after drying will be in flake form and grinding is needed before feeding to fluidized bed plasma reactor. We used a jet milling process for our lithium titanate oxide LTO nanowire powder for controlling the size distribution of particles from 200 μm to 8 μm (FIG. 8). For this purpose, a Sturtevant 8-inch jet mill micronizer with 30 lbs/hr capacity is used. A jet mill uses a high-speed jet of compressed air (80-100 psi) to impact particles into each other and the fine particles are collected in a bag house filter. Jet milling the coarse powder allows for controlling the size distribution of powder and removes big chunks completely. Control variables for jet mill are powder feed rate and grind pressure.

### Example 6. Plasma Flame/Fluidized Bed Studies

First microwave plasma reactor is set up along with accessories (such as volumetric feeder, pump, bag house and cyclone) and plasma ignited and sustained for 8 hrs without any powder feed. Argon (2-3 slpm) is used to ignite the plasma and then immediately air and oxygen is flown. Plasma is maintained at 1.5-2.5 kW power, using 10-15 slpm of air, and 1 slpm of oxygen. Then dried powders are injected at the bottom on to highly dense oxygen rich microwave plasma jet with vertically upward flow with 4 inches in cross sectional diameter and 2 feet in length (generated using 2.45 GHz MW energy, 3 KW power) confined in a conical cavity. Powder flow rate will be between 20-40 gram per min and air will be used to entrain from volumetric feeder. The micron size powders when fluidized through hot oxygen plasma instantly (reaction time few seconds, e.g. 1-10 seconds) oxidizes (with faster reaction kinetics and transport limited region). Fine powder is collected in a bag house filter while bigger powders are collected in the cyclone separator.

Reactor is operated at 1-10 Kg/day scale by supplying 20-40 g/min of dried precursor feed for 8-10 hours or operation. Energy efficiency of the process is evaluated to meet target metrics of <2 kWh/Kg. The target energy efficiency is calculated based on the applied power of 2 kW, flow rate of 20 g/min which gives 1.6 kwh/kg energy efficiency. Parameters to control the reactor include: plasma power, gas flow rates, and feed size and rate. Powder size, crystallinity, size distribution, conversion/yield can be controlled by powder feed rate, and plasma discharge characteristics.

Conversion is directly influenced by feed rate, feed powder size, plasma flame and residence time. Higher microwave plasma power coupled with slower feed rate and higher atomization will improve conversion.

Particle size distribution and sinterability: Charging of particles in plasma can help with non-sintering of particles unlike other production techniques. Proper atomization of powder with a slower feed rate coupled with good fluidization can improve conversion as well as PSD. Size can be controlled by controlling the dimension of plasma jet. A longer plasma jet with longer residence time will create bigger particle allowing the droplet to coalesce.

### Example 7: Production of Core Shell Mixed Metal Oxide Particles

MIP approach can also be used to produce core-shell architectures such as Li[(Ni_{0.8}Co_{0.1}Mn_{0.1})_{0.8}(Ni_{0.5}Mn_{0.5})_{0.2}]O₂ and Li[(Ni_{0.8}Co_{0.2})_{0.8}(Ni_{0.5}Mn_{0.5})_{0.2}]O₂, with the Ni-rich core having great capacity while the shell Li[Ni_{0.5}Mn_{0.5}]O₂ offered thermal stability.

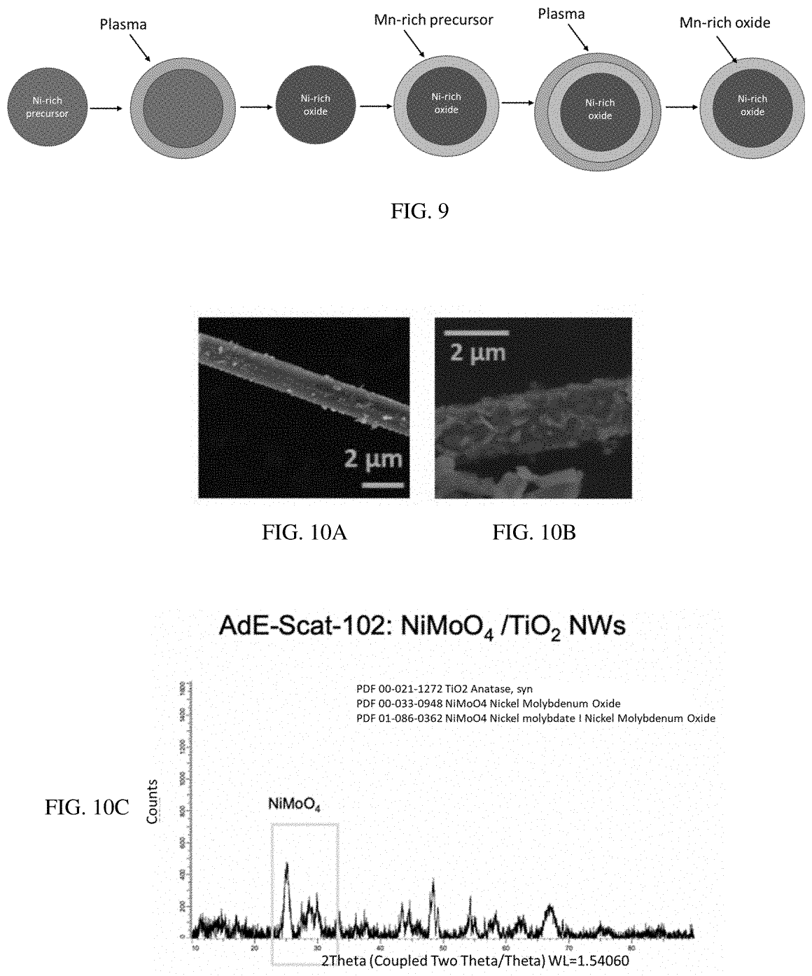

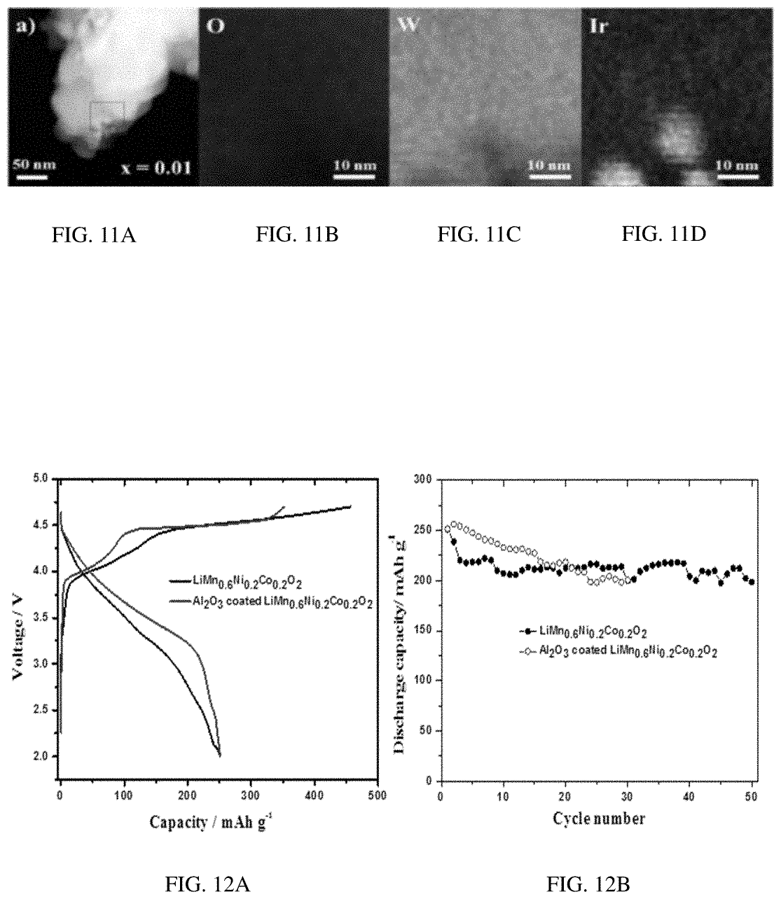

This approach includes two stages of synthesis with each step requiring precursors with different compositions as shown in FIG. 9. To prepare concentration gradient Ni-rich core and Mn-rich shell, nitrates of nickel manganese and cobalt is dissolved in distilled water to make coating solutions rich in Mn with molar proportions Ni/Mn/Co=2/6/2. The prepared coating solution is used to make a slurry with Ni-rich core NMC oxide previously synthesized and dried. The dried powder is jet milled and then finally exposed to plasma for 30 seconds. These steps are repeated with richer Mn solution (Ni/Mn/Co=1/8/1) in order to obtain Ni-rich core NMC materials with Mn-rich shell with a gradually decreasing Ni composition from core to shell in a concentration gradient manner. The obtained core-shell NMC oxide is well mixed in the solid state with an appropriate amount of Li₂CO₃ in such a way that the stoichiometric ratio of lithium to NMC will be 1:1, a 5 wt. % excess of Li₂CO₃ is added to compensate for the volatilization of lithium in the high temperature reaction. The mixture is then exposed to microwave plasma for post lithiation steps following the example above.

### Example 8. Production of NiMo Loaded on TiO₂ NWs Using MIP Scheme

NiMo has been widely used in commercial applications such as hydrogenation, hydrodesulfurization, hydrodeoxygenation, natural gas reforming and many more. FIG. 10 shows the SEM images of NiMo supported on TiO₂ NWs catalyst samples. On the left (FIG. 10(a)), conventional wet impregnation method was used and NiMo supported on TiO₂ NWs was produced. The mixture paste was dried and calcined in the furnace for 4 hours at 450° C. On the right (FIG. 10(b)), we exposed the mixture paste to the plasma flame for 45 seconds then the final catalyst composition was obtained. As can be seen in the SEM images, the active metal nanoparticle sizes and BET surface areas are different. FIG. 10 (c) shows the XRD graph of the NiMo/TiO₂ catalyst synthesized by plasma flame. The formation of NiMoO₄ alloy phases were observed. The crystal size for NiMoO₄ alloy particle was calculated based on Scherrer's equation as 24.8 nm.

MIP process is used to produce alloyed NiMo/TiO₂ catalyst. Two types of raw materials are fed to the fluid bed through powder feeder. The first type is similar to what we did at lab-scale before, using dry impregnation method, the Ni and Mo precursor solution droplets are impregnated into TiO₂ NWs, then the mixture is fully mixed in a rotary drum mixer. After that, the dry mixture is milled into 10 micron size and fed into the powder feed. The second type is using Ni and Mo precursors in dry salt powder directly, then fully mix the precursor powders with TiO₂ NWs powder. The mix powder particle size needs to be small enough to get through the powder feeder and fluidized bed reactor.

### Example 9: Production of OER Catalyst (W₁₋ₓIrₓO_{3-δ})

The method involves dissolving the metal precursors (ammonium paratungstate and Iridium acetate) in DI water to make 0.1 to 0.5 M solutions followed by drying the precursor solutions to obtain well mixed metal precursors. The powder is then processed by a jet mill method to obtain micron sized powder followed by pumping into a MW plasma fluidized bed reactor. The reaction time is on the order of <1 min.

### Example 10: Dry Coatings Using Fluidized Bed

The fluidized bed plasma reactor is also used for material coating the mixed metal oxide powders such as NMC. Coatings of powders used in battery materials could include non-reactive coating with Alumina (Al₂O₃), reactive coatings such as AlPO₄, carbon coating and conducting polymer (Polyaniline). Thin coatings (5-50 nm) on NMC could increase the bonding strength of metal ion with oxygen, increase the structure stability and decrease oxygen release effect on capacity during cycling. Coating can be performed directly in fluidized bed or above fluidized bed depending on the precursor and type of coating desired.

In general, the coating material is prepared from coating solutions of about 0.5 M, the prepared solution is used to incipiently wet the surface of already synthesized NMC oxide powder. In the case of alumina dry coating, precursor of Al(NO₃)₃·9 H₂O is dissolved in distilled water. Then the previously outlined procedure of drying, and subsequent plasma fluidized processing is performed in this procedure. FIG. 12 shows the charge discharge capacity of 5 nm thick Al₂O₃ coated NMC powder. For AlPO₄ coating, Al(NO₃)₃·9 H₂O and (NH₄)₂HPO₄ is dissolved in distilled water (in equimolar proportion) until a white suspension of AlPO₄ nanoparticles is obtained. The previously outlined procedure of drying and subsequent plasma processing is followed in this task.

Similar processes are used for the carbon coating by flowing the methane through the fluidized plasma reactor. NMC powder is fed through the fluidized bed plasma reactor along with 1-5 slm of methane gas. For conductive polymer coating PANI (Polyaniline) is used as the precursor and will be placed in a packed bed post plasma discharge (thermal heated and maintained at 200 deg C.) after exiting hot plasma area to avoid the decomposition of precursor at higher temperatures.

It is intended that the disclosure and examples be considered as exemplary only.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A method of manufacturing a mixed metal oxide powder, comprising:
mixing two or more metal precursors in a solvent to form a dispersion of the metal precursors in the solvent;
drying the dispersion to obtain a dried mixed metal precursor powder;
jet milling the dried mixed metal precursor powder to obtain particles having a size distribution in a range of 0.2-20 micrometers;
exposing the particles to a hydrocarbon flame or oxygen plasma; and then
recovering the mixed metal oxide powder.

2. The method of claim 1, wherein the two or more metal precursors comprise metals selected from the group consisting of nickel, manganese, cobalt, aluminum, magnesium, zirconium, lanthanum, lithium, sodium, potassium, calcium, silicon, platinum, ruthenium, tin, indium, bismuth, vanadium, iron, silver, copper, zinc, gallium, molybdenum, titanium, tungsten, and iridium.

3. The method of claim 1, wherein the two or more metal precursors are metal salts selected from the group consisting of nitrates, acetates, sulfates, formates, and combinations thereof.

4. The method of claim 1, wherein the solvent is an aqueous solvent.

5. The method of claim 1, wherein the drying step is performed to reduce a moisture content of the dried mixed metal precursor powder to less than 40% by wt.

6. The method of claim 1, wherein, in the exposing step, the particles are heated at a rate of 500-3000° C. per minute.

7. The method of claim 1, wherein the exposing step is performed for 10-120 seconds.

8. The method of claim 1, wherein, in the exposing step, the particles are exposed to an atmospheric pressure microwave plasma, radio frequency plasma torch, or any other form of plasma excitation.

9. The method of claim 1, wherein the dried mixed metal precursor powder is fluidized for exposure to the hydrocarbon flame or oxygen plasma.

10. The method of claim 1, further comprising adding a polymeric or inorganic coating to the mixed metal oxide powder.

11. The method of claim 1, further comprising adding a lithium precursor before or after the exposing step.

12. The method of claim 11, wherein the lithium precursor is lithium carbonate or lithium hydroxide.

13. The method of claim 1, wherein the method is repeated to provide core-shell mixed metal oxide particles having different compositions in each layer of the core-shell mixed metal oxide particles.

14. The method of claim 1 wherein the steps are performed such that concentration-gradient core-shell mixed metal oxide structures are produced.

15. A mixed metal oxide powder obtained by the method according to claim 1.
